(19) United States
(12) Patent Application Publication
(10) Pub. No.: US 2008/0064621 A1
(43) Pub. Date: Mar. 13, 2008

(54) Optically brightened aqueous compositions

(76) Inventors: Daniel Alan Jervis, Kingsport, TN (US); L. Palmer Holbrook, Kingsport, TN (US)

Correspondence Address: BRETT L. NELSON;EASTMAN CHEMICAL COMPANY, 100 NORTH EASTMAN ROAD, KINGSPORT, TN, 37660-5075, US

(21) Appl. No.: 11/516,881

(22) Filed: Sep. 7, 2006

(51) Int. Cl. C11D 3/00

(52) U.S. Cl. 510/394

(57) ABSTRACT

An aqueous composition that includes an optical brightener (e.g. a UV-fluorescent compound) and forms a coating when applied to an array of surfaces. The coating may be applied to polyester shrink wrap film making the film tamperproof when applied as packaging or over packaging closures. A method of making the aqueous composition as well as a method of applying the aqueous composition to a substrate or surface.

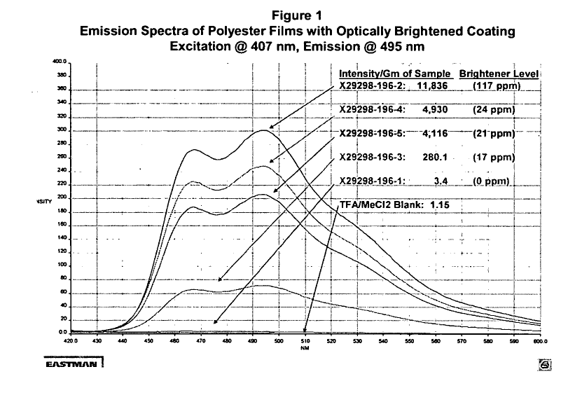

### FIELD OF THE INVENTION

The present invention relates to an aqueous composition that includes an optical brightener (e.g. a UV-fluorescent compound) and forms a coating when applied to an array of surfaces. For example, the coating may be applied to polyester shrink wrap film making the film tamperproof when applied as packaging or over packaging closures. The present invention also relates to a method of making the aqueous composition as well as a method of applying the aqueous composition to a substrate or surface.

### BACKGROUND

Optical brighteners are often used in polymeric compositions to enhance product color and/or to act as tracers. Optical brighteners, such as 2,5-thiophenediylbis (5-tert-butyl-1,3-benzoxazole), e.g., EASTOBRITE OB, and 2,2′-(ethenediyldi-4,1-phenylene) bisbenzoxazole, e.g., OB-1 and OB-3, function by absorbing light in the invisible, UV range (360-380-nm) and emitting light in the visible range (400-600 nm). This characteristic of optical brighteners makes them effective in masking inherent yellowness of polymers, because they emit in the blue, visible region. However, the characteristic which allows brighteners to be used as tracers is that they fluoresce in the UV range. UV-fluorescence has allowed brighteners to be used to trace thoroughness of mixing, uniformity of layering, presence of residue and tampering of security seals.

Some fabricators of shrink film can make their product tamper proof by including a brightener in the polymer. However, including the brightener into the shrink film can result in the brightener residue contaminating non-brightened products and process equipment (such as hoppers, extruders, dies, molds and other process equipment). The present invention addresses this and other problems by allowing a brightener to be coated, or applied, to a substrate (such as shrink film) after the substrate has been produced.

### SUMMARY OF THE INVENTION

An embodiment of the present invention concerns an optically brightened aqueous composition or fluorescent coating. The aqueous composition includes at least one optical brightener, a solvent, an effective amount of a water-dissipatable polyester, and water in an amount from about 55 weight % to about 95 weight % water.

Another embodiment concerns a method for making an optically brightened aqueous composition or fluorescent coating. The method includes combining a water-dissipated polyester and water to form a first mixture, combining an optical brightener and a solvent for the optical brightener to form a second mixture, and combining the first and second mixtures to form the aqueous composition.

Yet another embodiment concerns a method of applying the optically brightened aqueous composition or fluorescent coating to a substrate.

### DETAILED DESCRIPTION OF THE DRAWING

The drawing shows the emission spectra of polyester films coated with an optically brightened aqueous composition of the present invention.

### DETAILED DESCRIPTION OF THE INVENTION

In accordance with the present invention, an aqueous composition is provided for applying a non-water soluble optical brightener (e.g. UV-fluorescent compound) to a substrate. The aqueous composition includes at least one optical brightener, a solvent for the optical brightener, an effective amount of a water-dissipatable polyester derived from a dicarboxylic acid component and a diol component and a difunctional monomer containing a —SO₃M group attached to an aromatic nucleus to at least partially disperse the additive, and from about 55 weight % to about 95 weight % water, wherein the percentages are based on the total weight of the components in the aqueous composition.

The optical brightener is present in the composition ranging from about 0.0003 weight % to about 0.03 weight %, desirably from about 0.0005 weight % to about 0.0075 weight % and more desirably from about 0.0010 weight % to about 0.0050 weight %, based on the total weight of the constituents of the composition of the invention. The above optical brightener is desirably used to coat the substrate in amounts ranging from about 0.0015 weight % to about 0.025 weight % and preferably from about 0.0030 weight % to about 0.017 weight %.

A non-exhaustive list of optical brighteners that can be employed in the practice of the present invention include 2,2′-(2,5-thiophenediyl)bis[5-(1,1-dimethylethyl )]-benzoxazole; 2,2′-(1,4-naphthalenediyl) bis-benzoxazole; 4,4′-bis[2-(2-methoxyphenyl) etheneyl]-1-1′-biphenyl; and 1,4-bis(2-cyano styryl) benzene.

The water-dissipatable polyester is essentially derived from the following components: A) at least one dicarboxylic acid; B) at least one diol where at least 20 mole percent of the diol is composed of an ethylene glycol having the formula H(OCH₂CH₂)ₙOH where n is an integer of from two to about twenty; and C) at least one difunctional dicarboxylic acid sulfomonomer containing a —SO₃M group attached to an aromatic nucleus, wherein M is hydrogen or Na⁺, Li⁺, K⁺, Mg⁺⁺, Ca⁺⁺, Cu⁺⁺, Fe⁺⁺, Fe⁺⁺⁺, or a combination thereof. The sulfomonomer component of the polyester constitutes from about 8 mole percent to about 45 mole percent of the total moles in constituents A-C. Such water-dissipatable polyesters are described in greater detail in U.S. Pat. No. 3,546,008 issued to Shields et al. and U.S. Pat. No. 3,779,993 issued to Kibler et al., the entire disclosures of which are incorporated herein by reference.

Generally, the dicarboxylic acid component of the water-dissipatable polyester can be any aliphatic, cycloaliphatic, or aromatic acid. Examples of such dicarboxylic acids include oxyalic; malonic; dimethylmalonic; succinic; glutaric; adipic; trimethyladipic; pimelic; 2,2-dimethylglutaric; azelaic; sebacic; fumaric; maleic; itaconic; 1,3-cyclopentanedicarboxylic; 1,2-cyclohexanedicarboxylic; 1,3-cyclohexanedicarboxylic; 1,4-cyclohexanedicarboxylic; phthalic terephthalic; isophthalic; 2,5-norbornanedicarboxylic; 1,4-naphthalic; diphenic; 4,4′-oxydibenzoic; diglycolic; thiodipropionic; 4,4′-sulfonyldibenzoic; and 2,5-naphthalenedicarboxylic acids.

It should be understood that the use of the corresponding acid anhydrides, esters, and acid chlorides of these acids are included in the term “dicarboxylic acid”. The esters are preferred, examples of which include dimethyl 1,4-cyclohexanedicarboxylate; dimethyl 2,6-naphthalene dicarboxylate; dibutyl 4,4′-sulfonyldibenzoate; dimethyl isophthalate; dimethyl terephthalate; and diphenyl terephthalate. Copolyesters may be prepared from two or more of the above dicarboxylic acids or derivatives thereof.

At least 20 mole percent of the diol component used in preparing the linear water dissipatable polyester is a poly(ethylene glycol) having the formula H(OCH₂CH₂)ₙOH where n is an interger of from two to about twenty. Examples of preferred poly(ethylene glycols) include diethylene, triethylene, tetraethylene, pentaethylene, hexaethylene, heptaethylene, octaethylene, nonaethylene, decaethylene glycols and mixtures thereof. The remaining portion of the diol component is at least one aliphatic, cycloaliphatic, or aromatic diol. Examples of these diols include ethylene glycol; propylene glycol, 1,3-propanediol; 2,4-dimethyl-2-ethylhexane-1,3-diol; 2,2-dimethyl-1,3-propanediol; 2-ethyl-2-butyl-1,3-propanediol; 2-ethyl-2-isobutyl-1,3-propanediol; 1,3-butanediol; 1,4-butanediol; 1,5-pentanediol; 1,6-hexanediol; 2,2,4-trimethyl-1,6-hexanediol; 1,2-cyclohexane-dimethanol; 1,3-cyclohexanedimethanol; 1,4-cyclohexane-dimethanol; 2,2,4,4-tetramethyl-1,3-cyclobutanediol; and p-xylylenediol.

The third constituent of the water dissipatable polyester is a difunctional monomer containing a —SO₃M group attached to an aromatic nucleus, wherein M is hydrogen or a metal ion and may be added directly to the reaction mixture from which the polyester or polyesteramide is made. This difunctional monomer component may be either a dicarboxylic acid, or derivative thereof, containing a —SO₃M group or a diol containing a —SO₃M group. The metal ion of the sulfonate salt group may be Na⁺, Li⁺, K⁺, Mg⁺⁺, Ca⁺⁺, Cu⁺⁺, Fe⁺⁺, Fe⁺⁺⁺ or combinations thereof. The —SO₃M moiety is attached to the aromatic nucleus, examples of which include benzene, naphthalene, anthracene, diphenyl, oxydiphenyl, solfonyidiphenyl, and methylenediphenyl.

The amount of water-dissipatable polyester present in the composition of the invention can range from about 5 weight % to about 40 weight %, preferably from about 10 weight % to about 35 weight % and more preferably from about 15 weight % to about 30 weight %. based on the total weight of the constituents in the composition.

One skilled in the polyester art will understand that by changing the proportions of the various acids which make up the dicarboxylic acid component of the polyester or polyesteramide, the properties of the polymer may be varied to meet specific end uses. For example, as the proportion of terephthalic acid is decreased, the polymer becomes more flexible. Moreover, varying the mole percentages of sulfonate-containing difunctional monomer varies the water susceptibility of the polymer.

Solvents useful in the present invention include those solvents into which the optical brightener will dissolve. Such solvents include alcohols, acetone, cyclohexanone, ethyl acetate, methyl acetate, methyl ethyl ketone, and mixtures thereof.

Alcohols useful in the present invention include methyl alcohol, ethyl alcohol, n-propyl alcohol, isopropyl alcohol, n-butyl alcohol, sec-butyl alcohol, tert-butyl alcohol, amyl alcohol and its commercially available isomers.

The amount of water used to form the aqueous composition is from about 55 weight % to about 95 weight % and preferably from about 65 weight % to about 85 weight % and more preferably from about 70 weight % to about 80 weight %, based on the total weight of the constituents in the aqueous composition.

In accordance with another embodiment of the present invention, there is provided a method for making an optically brightened aqueous composition or fluorescent coating. In an embodiment according to the present invention, the method includes combining a water dispersable (dissipatable) polyester and water to form a first mixture (Part A), combining an optical brightener and a solvent to form a second mixture (Part B), and then mixing the first and second mixture to form the aqueous composition. It is desirable that the first and second mixtures be combined at an amount of about 85% to about 99% first mixture and about 1% to about 15% second mixture. The first and second mixtures can also be combined in an amount from about 90% to about 98% first mixture and about 2% to about 10% second mixture. The first and second mixtures can also be combined in an amount from about 95% to about 97% first mixture and about 3% to about 5% second mixture.

In accordance with another embodiment of the invention there is provided a method for applying the aqueous composition to a substrate (e.g. a polyester shrink-wrap film). The method includes applying the aqueous composition according to the present invention to a substrate (e.g. a shrink wrap film) by either a gravure or flexographic process. Both processes are known to those of skill in the art. For example, a basic gravure process could include applying the optically brightened aqueous composition to a metal plate. Then rotating the plate on a cylinder while the cylinder is in contact with a substrate to thereby transfer the aqueous composition to the substrate. Flexographic methods are similar to gravure methods except flexography uses flexible printing plates made of rubber or plastic to which the aqueous composition is applied. The plate is then similarly rotated on a cylinder while the cylinder is in contact with a substrate to thereby transfer the aqueous composition to the substrate.

One application of the present invention concerns an aqueous composition or optically brightened coating (e.g. a UV-fluorescent coating) that will act as a tamper proof seal when applied to polyester shrink film. By applying optical brightener via coating, the film fabricator can avoid contaminating extruders and other process equipment with the additive. Other applications concern the use of the optical brightener coating as a primary vehicle or binder for water-based gravure and flexographic printing inks. The coating may also be used to carry optical brightener into water based adhesives, hard surface cleaners/protectors, water removable protective coatings for metal, plastic, wood and glass, and cosmetic film formers (e.g., nail polish).

### EXAMPLES

The UV-fluorescent coating (Table I) was applied to a polyester shrink film (10 mil) at wet coating thicknesses of 10, 15 and 20 mils. This produced dry coating thicknesses of ˜3, ˜4.5 and ˜6 mils, based on coating solids of ˜30 percent. The coated films were stretched at 100° C. by 4 times their original length to ensure coating integrity during the shrink wrap process. A control film without coating (stretched) and film with coating (˜3 mils, non-stretched) were included. Subjective examination of the stretched films showed no adverse effect on the coating. Examination of the coated film under UV light showed flaws intentionally introduced to test the merit of the coating as a security seal. Fluorescence intensity emission spectra (at 407 nm) were measured using a Perkin-Elmer LS50B luminescence spectrometer. Test data given in Table II and in the Figure show that optically brightened coatings with high fluorescence intensity were successfully applied to polyester shrink film. Observations and measurements of spectra after stretching indicate that the coating possesses enough integrity to withstand the shrink wrap process and that evidence of tampering (film flaws) are evident when examined under an UV lamp.

### By applying optical brightener to shrink wrap film via coating, the film fabricator can avoid contaminating hoppers, extruders, dies, molds and other process equipment with the additive.

TABLE I
UV-Fluorescent Coating Based on Eastman AQ 48 Ultra
Polymer and Eastobrite OB Optical Brightener

| Ingredients | Percent |
|---|---|
| Deionized Water | 67.9 |
| Eastman AQ 48 Ultra Polymer | 29.1 |
| N-Propyl Alcohol (1-propanol) | 2.9955 |
| Eastobrite OB Optical Brightener | 0.0045 |

Note:
The coating possessed a pH of ~6.

TABLE II
Fluorescence Intensity of Stretched Polyester* Film Coated with
Optically Brightened Eastman AQ 48 Ultra Polymer

| | Wet | | Eastobrite OB | Fluorescence |
|---|---|---|---|---|
| | Coating | Stretched @ | Optical Brightener | Intensity/ |
| Sample | Thickness | 100° C., 4 × 1, | (Level in ppm by | Gm of |
| No. | (mils) | 4× | assay of film) | Sample |
| 1 | 0 | Yes | 0 | 3 |
| 2 | 10 | No stretch | 117 | 11,836 |
| 3 | 10 | Yes | 17 | 280 |
| 4 | 15 | Yes | 24 | 4,930 |
| 5 | 20 | Yes | 21 | 4,116 |

*Embrace (Product of EASTMAN)
Note:
Optical brightener levels were determined by UV-Visible spectroscopy; Fluorescence Intensity was determined by Perkin-Elmer LS50B luminescence spectrophotometer.

### Method for Preparation of Optically Brightened Coating

### Part A Mix

1. Heat deionized water (70%) in a beaker using a hot plate or heating mantle to a temperature of 45°-50° C.
2. Begin rapid agitation using a mechanical stirrer, while slowly adding to the water sulfopolyester pellets, i.e., AQ 48 Ultra Polymer (30%).
3. Continue to stir while maintaining temperature until the polymer is completely dispersed.
4. Cool to room temperature.

### Part B Mix

1. Blend 1-propanol (99.85%) with 2,5-thiophenediylbis (5-tert-butyl-1,3-benzoxazole), i.e., Eastobrite OB optical brightener (0.15%).

### Final Mix

1. Blend 97% Part A with 3% Part B in a beaker and agitate with a mechanical stirrer until homogenous.

### Result—An optically brightened (UV-fluorescent) coating containing an optical brightener level of ˜45 ppm on a wet basis or ˜155 ppm upon drying.

The invention has been described in detail with particular reference to preferred embodiments thereof, but it will be understood that variations and modifications can be effected within the spirit and scope of the invention.

1. An optically brightened aqueous composition, comprising:
at least one optical brightener;
a solvent;
an effective amount of a water-dissipatable polyester; and
water,
wherein the optical brightener is selected from the group consisting of 2,2′-(2,5-thiophenediyl) bis[5-(1,1-dimethylethyl)]-benzoxazole; 2,2′-(1,4-naphthalenediyl) bis-benzoxazole; 4,4′-bis[2-(2-methoxyphenyl) etheneyl]-1-1′-biphenyl; and 1,4-bis(2-cyano styryl) benzene..

2. The composition according to claim 1, wherein the water-dissipatable polyester is derived from a dicarboxylic acid component and a diol component and a difunctional monomer containing a —SO₃M group attached to an aromatic nucleus.

3. The composition according to claim 1, wherein the optical brightener is present in the composition ranging from about 0.0003 weight % to about 0.03 weight %.

4. The composition according to claim 3, wherein the optical brightener is present in the composition ranging from about 0.0005 weight % to about 0.0075 weight %.

5. The composition according to claim 4, wherein the optical brightener is present in the composition ranging from about 0.0010 weight % to about 0.0050 weight %.

6. (canceled)

7. The composition according to claim 1, wherein the water-dissipatable polyester is derived from
A) at least one dicarboxylic acid;
B) at least one diol wherein at least 20 mole percent of the diol is composed of an ethylene glycol having the formula H(OCH₂CH₂)ₙOH where n is an integer of from two to about twenty; and
C) at least one difunctional dicarboxylic acid sulfomonomer containing a SO₃M group attached to an aromatic nucleus, wherein M is hydrogen, metal ion or a combination thereof.

8. The composition according to claim 7, wherein the dicarboxylic acid is an aliphatic, a cycloaliphatic, or an aromatic acid.

9. The composition according to claim 8, wherein the dicaroxylic acid is selected from the group consisting of oxyalic acid; malonic acid; dimethylmalonic acid; succinic acid; glutaric acid; adipic acid; trimethyladipic acid; pimelic acid; 2,2-dimethylglutaric acid; azelaic acid; sebacic acid; fumaric acid; maleic acid; itaconic acid; 1,3-cyclopentanedicarboxylic acid; 1,2-cyclohexanedicarboxylic acid; 1,3-cyclohexanedicarboxylic acid; 1,4-cyclohexanedicarboxylic acid; phthalic terephthalic acid; isophthalic acid; 2,5-norbornanedicarboxylic acid; 1,4-naphthalic acid; diphenic acid; 4,4′-oxydibenzoic acid; diglycolic acid; thiodipropionic acid; 4,4′-sulfonyldibenzoic acid; and 2,5-naphthalenedicarboxylic acid.

10. The composition according to claim 7, wherein ethylene glycol is selected from the group consisting of ethylene glycol, propylene glycol, diethylene glycol, triethylene glycol, tetraethylene glycol, pentaethylene glycol, hexaethylene glycol, heptaethylene glycol, octaethylene glycol, nonaethylene glycol, decaethylene glycol and mixtures thereof.

11. The composition according to claim 7, wherein the diol includes at least one aliphatic diol, cycloaliphatic diol, or aromatic diol.

12. The composition according to claim 7, wherein the metal ion is selected from the group consisting of Na⁺, Li⁺, K⁺, Mg⁺⁺, Ca⁺⁺, Cu⁺⁺, Fe⁺⁺, Fe⁺⁺⁺, and combinations thereof.

13. The composition according to claim 1, wherein the water-dissipatable polyester is present in an amount from about 5 weight % to about 40 weight %

14. The composition according to claim 13, wherein the water-dissipatable polyester is present in an amount from about 10 weight % to about 35 weight %.

15. The composition according to claim 14, wherein the water-dissipatable polyester is present in an amount from about 15 weight % to about 30 weight %.

16. The composition according to claim 1, wherein the solvent is selected from the group consisting of an alcohol, an acetone, a cyclohexanone, an ethyl acetate, a methyl acetate, a methyl ethyl ketone, and combinations thereof.

17. The composition according to claim 16, wherein the alcohol is selected from the group consisting of methyl alcohol, ethyl alcohol, n-propyl alcohol, isopropyl alcohol, n-butyl alcohol, sec-butyl alcohol, tert-butyl alcohol, amyl alcohol mixtures thereof.

18. The composition according to claim 1, wherein water is present in the composition in an amount from about 55 weight % to about 95 weight %.

19. The composition according to claim 18, wherein water is present in the composition in an amount from about 65 weight % to about 85 weight %.

20. The composition according to claim 19, wherein water is present in the composition in an amount from about 70 weight % to about 80 weight %.

21. A substrate coated with the composition according to claim 1.

22. A shrink wrap film coated with the composition according to claim 1.

23. A method for making an optically brightened aqueous composition, comprising:
combining a water-dissipated polyester and water to form a first mixture;
combining an optical brightener and a solvent to form a second mixture; and
combining the first and second mixture to form the aqueous composition.

24. The method according to claim 23, wherein the first mixture and second mixture are combined at an amount of about 85% to about 99% first mixture and about 1% to about 15% second mixture.

25. The method according to claim 22, wherein the first mixture and second mixture are combined in an amount from about 90% to about 98% first mixture and about 2% to about 10% second mixture.

26. The method according to claim 25, wherein the first mixture and second mixture are combined in an amount from about 95% to about 97% first mixture and about 3% to about 5% second mixture.

27. A method for applying an optically brightened aqueous composition to a substrate comprising:
applying the optically brightened aqueous composition according to claim 1 to a substrate.

28. The method according to claim 27, wherein the optically brightened aqueous composition is applied to the substrate by a gravure process or a flexographic process.

29. The method according to claim 27, wherein the substrate is selected from the group consisting of a shrink wrap film, an adhesive, a hard surface cleaner, a protective coating for metal, a protective coating for plastic, a protective coating for wood, a protective coating for glass, and a cosmetic film former.
